(19) United States
(12) Patent Application Publication
(10) Pub. No.: US 2015/0129464 A1
(43) Pub. Date: May 14, 2015

(54) METHOD OF FILTERING A SOLVENT-CONTAINING SLURRY STREAM IN A NON-AQUEOUS OIL SAND EXTRACTION PROCESS

(71) Applicants: Shell Canada Energy, Calgary (CA); Chevron Canada Limited, Calgary (CA); Marathon Oil Sands L.P., Calgary (CA)

(72) Inventors: Ingmar Hubertus Josephina PLOEMEN, Amsterdam (NL); Jovan JOVANOVIC, Amsterdam (NL); Bernardus Cornelis Maria IN' T VEEN, Amsterdam (NL); Julian Robert KIFT, Reno, NV (US); Cherish Marie HOFFMAN, Reno, NV (US)

(21) Appl. No.: 14/535,131

(22) Filed: Nov. 6, 2014

Related U.S. Application Data
(60) Provisional application No. 61/901,664, filed on Nov. 8, 2013.

(51) Int. Cl. C10G 1/04; B01D 33/76; B01D 33/17; B01D 33/44

(52) U.S. Cl. CPC C10G 1/045; B01D 33/44; B01D 33/76; B01D 33/17
USPC 208/390; 210/391

(57) ABSTRACT

The present invention provides a method of filtering a solvent-containing slurry stream including: (a) providing a solvent-containing slurry stream, the solvent comprising an aliphatic hydrocarbon; (b) depositing the solvent-containing slurry stream provided in step (a) as a filter cake on a filter medium, wherein a top layer of liquid is formed on the filter cake; (c) allowing the top layer of liquid as formed in step (b) to drain through the filter cake such that substantially no liquid remains on top of the filter cake; (d) allowing a gas to partially penetrate into the filter cake thereby obtaining a filter cake with a liquid solvent-depleted top layer; (e) passing liquid solvent through the filter cake with the liquid solvent-depleted top layer as obtained in step (d) thereby obtaining a washed filter cake; (f) removing solvent from the washed filter cake as obtained in step (e) thereby obtaining a solvent-depleted filter cake; and (g) removing the solvent-depleted filter cake as obtained in step (f) from the filter medium.

### RELATED APPLICATIONS

This application claims the benefit of U.S. Provisional Application No. 61/901,664 filed Nov. 8, 2013, which is incorporated herein by reference.

### BACKGROUND

The present invention relates to a method of filtering a solvent-containing slurry stream in a non-aqueous oil sand extraction process (i.e. using a non-aqueous solvent).

Various methods have been proposed in the past for the recovery of bitumen (sometimes referred to as ‘tar’ or ‘bituminous material’) from oil sands as found in various locations throughout the world and in particular in Canada such as in the Athabasca district in Alberta and in the United States such as in the Utah oil sands. Typically, oil sand (also known as ‘bituminous sand’ or ‘tar sand’) comprises a mixture of bitumen (in this context also known as ‘crude bitumen’, a semi-solid form of crude oil; also known as ‘extremely heavy crude oil’), sand, clay minerals and water. Usually, oil sand contains about 5 to 25 wt. % bitumen (as meant according to the present invention), about 1 to 13 wt. % water, the remainder being sand and clay particles.

As an example, it has been proposed and practiced at commercial scale to recover the bitumen content from the oil sand in an extraction process by mixing the oil sand with water and separating the sand from the aqueous phase of the slurry formed.

Other methods have proposed non-aqueous extraction processes (i.e. using a non-aqueous solvent) to reduce the need for large quantities of process water.

A potential problem of processes using non-aqueous extraction of bitumen from oil sand is the possible occurrence of asphaltene precipitation in the filter used for filtration of a solvent-containing slurry stream (typically when liquid non-aqueous solvent is added to the slurry for extraction of the bitumen). These precipitated asphaltenes may deposit on top and/or inside the formed filter cake resulting in decrease of filtration rate and/or blocking of the filter cake. In case of severe blocking of the filter cake, liquid flow through the filter cake may not be possible, resulting in flooding of the filter.

A further problem represents the need to separate the liquid (known in filtration theory as the “mother liquor”) in the solvent-containing slurry stream (comprising the non-aqueous solvent and dissolved bitumen and asphaltenes) entering the filter from the liquid solvent used to wash the filter cake in the filter. The need to separate this liquid arises from the situation that the mixing of the liquid in the solvent-containing slurry stream and the liquid solvent may result in precipitation of asphaltenes. These precipitated asphaltenes may form a layer with a high resistance to flow (i.e. low permeability) on top of the filter cake, impeding or even blocking flow through the filter cake. In case of blockage, the solid-liquid separation will not be able to be completed during the filtration step, resulting in negative outcomes ranging from off-spec (high moisture) filter cake at the filter discharge to complete flooding of the filter and filter unit trips.

It is an object of the present invention to avoid or at least minimize the above problems.

One or more of the above or other objects may be achieved according to the present invention by providing a method of filtering a solvent-containing slurry stream in a non-aqueous oil sand extraction process, the method comprising at least the steps of:

(a) providing a solvent-containing slurry stream, the solvent comprising an aliphatic hydrocarbon;
(b) depositing the solvent-containing slurry stream provided in step (a) as a filter cake on a filter medium, wherein a top layer of liquid is formed on the filter cake;
(c) allowing the top layer of liquid as formed in step (b) to drain through the filter cake such that substantially no liquid remains on top of the filter cake;
(d) allowing a gas to partially penetrate into the filter cake thereby obtaining a filter cake with a liquid solvent-depleted top layer;
(e) passing liquid solvent through the filter cake with the liquid solvent-depleted top layer as obtained in step (d) thereby obtaining a washed filter cake;
(f) removing solvent from the washed filter cake as obtained in step (e) thereby obtaining a solvent-depleted filter cake; and
(g) removing the solvent-depleted filter cake as obtained in step (f) from the filter medium.

It has now surprisingly been found that the method according to the present invention avoids the occurrence of filter blocking in a non-aqueous oil sand extraction process by asphaltene precipitation on top of a filter cake.

A further advantage of the present invention is that it results in shorter filtration times.

The person skilled in the art is familiar with a non-aqueous oil sand extraction process; hence this will not be described here in further detail. Typically, a non-aqueous oil sand extraction process comprises at least the steps of:
reducing the oil sand ore in size, e.g. by crushing, breaking and/or grinding, to below a desired size upper limit (such as for example 20 inch);
contacting the oil sand with a non-aqueous solvent, thereby obtaining a solvent-diluted oil sand slurry;
filtering the solvent-diluted oil sand slurry (whilst possibly applying pressure-filtration), thereby obtaining a solids-depleted stream and a solids-enriched stream (‘filter cake’); and
removing solvent from the solids-depleted stream obtained thereby obtaining a bitumen-enriched stream that can be further processed to obtain the bitumen. The bitumen may subsequently be further processed in e.g. a refinery.

In step (a), a solvent-containing slurry stream is provided. As mentioned above, the solvent-containing slurry stream is obtained in a non-aqueous oil sand extraction process (i.e. using a non-aqueous solvent).

The solvent as used in the method of the present invention may—provided it comprises an aliphatic hydrocarbon - be selected from a wide variety of non-aqueous solvents (although a small amount of water may be present), aromatic hydrocarbon solvents and saturated or unsaturated aliphatic (i.e. non-aromatic) hydrocarbon solvents; aliphatic hydrocarbon solvents may include linear, branched or cyclic alkanes and alkenes and mixtures thereof. Preferably, the solvent in step (a) (to which in the art is often referred to with the term ‘mother liquor’) comprises an aliphatic hydrocarbon having from 3 to 9 carbon atoms per molecule, more preferably from 4 to 7 carbons per molecule, or a combination thereof. Especially suitable solvents are saturated aliphatic hydrocarbons such as propane, butane, pentane, hexane, heptane, octane and nonane (including isomers thereof), in particular butane, pentane, hexane and heptanes, preferably pentane. It is preferred that the solvent in step (a) comprises at least 50 wt. %, preferably at least 90 wt. % of the aliphatic hydrocarbon (preferably having from 3 to 9 carbon atoms per molecule), more preferably at least 95 wt. %. Also, it is preferred that in step (a) substantially no aromatic solvent (such as toluene or benzene) is present, i.e. less than 5 wt. %, preferably less than 1 wt. %. Further it is preferred that a single solvent is used as this avoids the need for a distillation unit or the like to separate solvents. Also, it is preferred that the solvent has a boiling point lower than that of the bitumen to facilitate easy separation and recovery.

Preferably, the solvent-containing slurry stream provided in step (a) comprises from 30 to 60 vol. % solids, preferably above 35 vol. %, more preferably above 45 vol. % and preferably below 55 vol. %.

Further, it is preferred that the solvent-containing slurry stream provided in step (a) has a solvent-to-bitumen (S/B) weight ratio of from 0.5 to 9.0, preferably above 0.6 and preferably below 2.0, more preferably below 1.5 (the latter in particular in case the solvent comprises pentane).

Also, it is preferred that the solvent-containing slurry stream provided in step (a) contains from 2.0 wt. % to 50 wt. % (non-aqueous) solvent, preferably at least 3.0 wt. %, more preferably at least 4.0 wt. % and preferably at most 30 wt. %, more preferably at most 25 wt. %, based on the weight of the solids in the solvent-containing slurry stream. Furthermore, it is preferred that the solvent-containing slurry stream provided in step (a) contains from 1.0 wt. % to 10 wt. % water, preferably at least 3.0 wt. % and preferably at most 7.0 wt. %, based on the weight of the solids in the solvent-containing slurry stream.

Also it is preferred, that the solvent-containing slurry stream provided in step (a) contains from 0.1 wt. % to 15 wt. % bitumen, preferably at least 0.2 wt. %, more preferably at least 0.5 wt. %, based on the weight of the solids in the solvent-containing solids stream.

In step (b), the solvent-containing slurry stream provided in step (a) is deposited as a filter cake on a filter medium, wherein a top layer of (excess mother) liquid is formed on the filter cake. The person skilled in the art will readily understand that the filter medium (which is typically supported by a filter medium support or a filter cell) is not limited; suitable filter media are a grid, a mesh, a slit and other filter media known in the art. Also, the depositing of the filter cake is not limited in any way and can be performed in various ways. Typically, the filter cake has a thickness of from 40 to 200 mm Further, the top layer of liquid is typically from 5 to 50 mm Usually, the top layer of liquid is a mixture of non-aqueous solvent and bitumen (and typically asphaltenes, water traces and possibly other trace components); preferably the liquid has a (non-aqueous) solvent-to-bitumen (S/B) weight ratio of from 0.5 to 5.0.

In step (c), the top layer of liquid as formed in step (b) is allowed to drain through the filter cake such that substantially no liquid remains on top of the filter cake. In principle a very small amount may remain, but preferably no liquid remains on top of the filter at all.

Preferably, the top section of the filter cake having substantially no liquid remaining on top of the filter cake as obtained in step (c) is remixed before liquid solvent is passed therethrough in step (d). The person skilled in the art will readily understand that this remixing can be done in various ways and typically involves breaking up or disturbing any formed layer of asphaltenes to ensure penetration of liquid through the filter. This remixing and/or breaking up can be done using e.g. a spring, plough, harrow, knife or the like which may be connected to a top wall or bar above the filter cake and is hanging down therefrom. Typically the thickness of the top section is from 5 to 50 mm and/or from 5 to 15% of the thickness of the filter cake.

In step (d), a gas is allowed to partially penetrate into the filter cake (having substantially no liquid remaining on top thereof) thereby obtaining a filter cake with a liquid solvent-depleted top layer. If desired, the draining in step (c) and the partial penetrating of gas in step (d) can be performed at the same time (e.g. draining whilst applying gas pressure, eventually resulting in partial penetration).

This step (d) avoids mixing of the (excess mother) liquid on top of the filter cake originating from the solvent-containing slurry stream provided in step (a) as fed to the filter and the liquid solvent Nash liquid') being passed through the filter cake in step (e). Mixing of these two liquids would result in precipitation of asphaltenes to occur on top of the filter cake as the asphaltene solubility decreases at increasing solvent content of the mixed liquid (although some asphaltene precipitation within pores may occur).

The gas used in step (d) is typically selected from N₂ and an aliphatic hydrocarbon, preferably having from 3 to 9 carbon atoms per molecule, more preferably from 4 to 7 carbons per molecule, or a combination thereof. Preferably the gas is pentane gas. Preferably, the gas penetrates as deep such that the upper 0.5 to 25% of filter cake height below the filter cake surface is substantially free of liquid solvent; hence the liquid solvent-depleted top layer makes out 0.5 to 25% of the filter cake height.

Preferably, the liquid solvent-depleted top layer of the filter cake as obtained in step (d) has a temperature of from 50° C. to 100° C., preferably at least 60° C. and preferably at most 90° C.

In step (e), liquid solvent (in the art often referred to with the term ‘wash liquid’) is passed through the filter cake with the liquid solvent-depleted top layer as obtained in step (d) thereby obtaining a washed filter cake (and passed liquid solvent). Typically, during the passing of liquid solvent through the filter cake, a pressure difference over the filter cake of from 0.05 to 3.5 bar is applied. The passed liquid solvent is collected (as this contains the extracted bitumen) and further processed to obtain a bitumen product. The person skilled in the art will understand that the supply and passing of liquid solvent in step (e) can be done in various ways, for example using wash bars, spray nozzles and the like. Further, the person skilled in the art will readily understand that several wash steps may be performed (by passing liquid solvent several times).

Preferably, the liquid solvent in step (e) comprises an aliphatic hydrocarbon, preferably having from 3 to 9 carbon atoms per molecule, more preferably from 4 to 7 carbons per molecule, or a combination thereof. The liquid solvent in step (e) preferably comprises no or only a very low amount of bitumen, such as below 0.5 wt %, but may in some embodiments contain a higher bitumen content. Preferably, the solvent as used in (the mother liquor of) step (a) is the same as the liquid solvent (‘wash liquid’) as used in step (e). Also, it is preferred that the gas as used in step (d) is the same as the solvent (albeit in a gaseous state) as used in steps (a) and (e) (and step (f)).

In step (f), solvent is removed from the washed filter cake as obtained in step (e) thereby obtaining a solvent-depleted filter cake. Preferably, from 5 to 25 vol. % of the filter cake pore volume is filled with liquid. The solvent may be removed from the washed filter cake in various ways. One preferred way of achieving this is by allowing gas to penetrate and flow through the filter cake thereby displacing the solvent.

In step (g), the solvent-depleted filter cake as obtained in step (f) is removed from the filter medium. Typically, the solvent-depleted filter cake as obtained in step (f) comprises from 0.01 to 1.0 wt. % bitumen, from 1.0 to 15 wt. % non-aqueous solvent (preferably at least 2.0 and at most 7.0 wt. %), based on the total amount of solvent-depleted filter cake.

The removal of the solvent-depleted filter cake can be performed in many ways, for example using a discharge scroll or the like. If desired, the solvent-depleted filter cake may be subjected to further drying steps for further solvent recovery.

In a further aspect, the present invention provides an apparatus for filtering a solvent-containing slurry stream in a non-aqueous oil sand extraction process, the apparatus comprising at least:
a slurry feeding section (in which the solvent-containing slurry stream is deposited on a filter medium);
a filter cake formation section (in which the solvent-containing slurry settles into a filter cake having a constant height and wherein a top layer of liquid is formed on the filter cake);
a separation zone (also including the passing of a gas to push out liquid solvent, in which during use a top layer of liquid as formed on the filter cake can drain through the filter cake;
a wash section, in which during use solvent can be supplied and can pass through the filter cake;
a solvent removal section (or ‘desolventation section’ or ‘demoisturing section’; in which typically a gas is passed through the filter cake to push out liquid solvent); and
a filter cake discharge section.

Preferably, the apparatus according to the present invention comprises a rotary pan filter. In this case, the apparatus typically further comprises a heel removal section in which the heel (the residual solids layer (typically 2.0 to 5.0 cm thick) remaining on the filter medium after discharge of the filter cake) is broken and remixed, e.g. using gas (such as N₂, air or any hydrocarbon used in the process) and/or non-aqueous solvent addition.

### EXAMPLES

The invention will be illustrated using the following non-limiting examples which were performed on a bench scale.

### Example 1 (Performed in Triplo)

A solvent-containing slurry having a solids content of 45 vol. % and an S/B (solvent-to-bitumen) weight ratio of 0.8 was provided by mixing (using a double cone blender) during 10 minutes of 40 kg of an oil sand ore (containing 13 wt. %

bitumen, 4 wt. % fines having a particle size of less than 44 um and 3 wt. % water) with fresh pentane and a mixture of bitumen and pentane (S/B of 0.8).

The slurry was deposited (whilst levelling using a sweep arm) using gravity from the mixer as a filter cake on a filter medium having a 400 mu pore size (304 stainless steel, obtainable from City Wire Cloth, Fontana CA, USA; open area 36%, opening size 0.015 inch, wire diameter 0.01 inch), wherein a top layer of excess liquid was formed on the filter cake. The filter cake was about 20 cm high.

Nitrogen gas was supplied to the top of the filter cake at a pressure of 0.34 barg. The top layer of excess liquid was allowed to drain through the filter cake such that substantially no excess liquid remained on top of the filter cake. The nitrogen gas was allowed to partially penetrate into the filter cake thereby obtaining a filter cake with a liquid solvent-depleted top layer.

A first amount of pentane was added as liquid solvent (or ‘wash liquid’) using a spray nozzle and passed at a pressure difference (across the filter cake) of 0.3 bar through the filter cake (with the liquid solvent-depleted top layer) at a S/B ratio of 0.8 and a wash ratio (mass of wash liquid/mass of cake) of 0.3. Once the first amount of pentane dropped just below the filter cake surface, a second amount of pentane was added to the filter cake at the same ratio as the first amount. The time and mass was recorded when the pentane dropped below the surface of the filter cake and when nitrogen breakthrough occurred. Once the breakthrough occurred (thereby obtaining a solvent-depleted filter cake), the filtration was stopped and the filter was depressurized and emptied by removing the solvent-depleted filter cake from the filter medium.

### Comparative Example 1 (Performed in Triplo)

The method of Example 1 was repeated, but without draining of the top layer of excess liquid and without allowing nitrogen gas to partially penetrate into the filter cake. Hence no filter cake with a liquid solvent-depleted top layer was obtained before passing the wash liquid through the filter cake.

Table 1 below shows the filtration times for Example 1 and Comparative Example (both performed in triplo)

TABLE 1

| Example | Filtration time [s] |
|---|---|
| Example 1 (1) | 26 |
| Example 1 (2) | 23 |
| Example 1 (3) | 31 |
| Comparative Example 1 (1) | 1273 |
| Comparative Example 1 (2) | 820 |
| Comparative Example 1 (3) | 1020 |

As can be seen from Table 1, the method according to the present invention results in significant improved (i.e. shorter) filtration times. Further it appeared that when wash liquid was added before draining the top layer of excess liquid and generating a filter cake with a liquid solvent-depleted top layer (as was the case for

Comparative Example 1), blocking of the filter cake occurred due to asphaltene precipitation. Further, it appeared that Example 1 resulted in a desirable bitumen recovery of about 86%.

### BRIEF DESCRIPTION OF THE DRAWING

Hereinafter the invention will be further illustrated by the following non-limiting drawing. Herein shows:

FIG. 1 schematically a top view of a non-limiting embodiment of a rotary pan filter suitable for use in a method in accordance with the present invention.

### DETAILED DESCRIPTION OF THE DRAWINGS

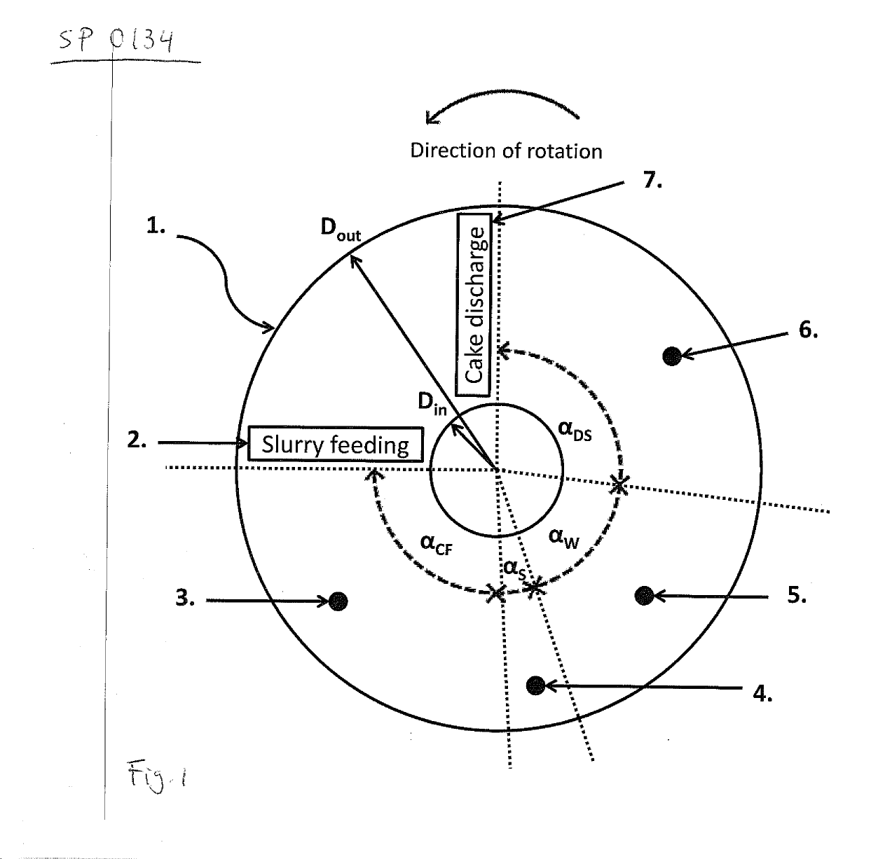

FIG. 1 schematically shows a rotary pan filter suitable for use in a method in accordance with the present invention for filtering a solvent-containing slurry stream in a non-aqueous oil sand extraction process. The rotary pan filter is generally referred to with reference numeral 1. The rotary pan vessel 1 comprises a slurry feeding section 2; a filter cake formation section 3 with a corresponding cake formation zone angle α_{CF}; a separation zone 4 (including the passing of a gas to push out liquid solvent) in which during use a top layer of liquid as formed on the filter cake can drain through the filter cake, with a corresponding separation zone angle α_{S}; a wash section 5, with a corresponding wash zone angle α_{W}, in which during use solvent can pass through the filter cake; a solvent removal (desolventation) section 6, with a corresponding desolventation zone angle α_{DS}; and a filter cake discharge section 7.

During use, a solvent-containing slurry stream is provided via the slurry feeding section 2 and is deposited as a filter cake on a filter medium in a filter cake formation section 3. In the filter cake formation zone, a top layer of liquid is formed on the filter cake. In the separation zone 4 the top layer of liquid is allowed to drain through the filter cake such that substantially no liquid remains on top of the filter cake. Further, also in the separation zone 4, after the top layer of liquid has been drained through the filter cake, a gas is allowed to partially penetrate into the filter cake thereby obtaining a filter cake with a liquid solvent-depleted top layer.

Then, in wash section 5, liquid solvent is passed through the filter cake with the liquid solvent-depleted top layer thereby obtaining a washed filter cake.

Subsequently, in solvent removal section 6 solvent is removed from the washed filter cake thereby obtaining a solvent-depleted filter cake. Thereafter, the solvent-depleted filter cake is removed from the filter medium in the filter cake discharge section 7.

The person skilled in the art will readily understand that many modifications may be made without departing from the scope of the invention. Further, the person skilled in the art will readily understand that, while the present invention in some instances may have been illustrated making reference to a specific combination of features and measures, many of those features and measures are functionally independent from other features and measures given in the respective embodiment(s) such that they can be equally or similarly applied independently in other embodiments.

We claim:

1. A method of filtering a solvent-containing slurry stream in a non-aqueous oil sand extraction process, the method comprising at least the steps of:
(a) providing a solvent-containing slurry stream, the solvent comprising an aliphatic hydrocarbon;
(b) depositing the solvent-containing slurry stream provided in step (a) as a filter cake on a filter medium, wherein a top layer of liquid is formed on the filter cake;
(c) allowing the top layer of liquid as formed in step (b) to drain through the filter cake such that substantially no liquid remains on top of the filter cake;
(d) allowing a gas to partially penetrate into the filter cake thereby obtaining a filter cake with a liquid solvent-depleted top layer;
(e) passing liquid solvent through the filter cake with the liquid solvent-depleted top layer as obtained in step (d) thereby obtaining a washed filter cake;
(f) removing solvent from the washed filter cake as obtained in step (e) thereby obtaining a solvent-depleted filter cake; and
(g) removing the solvent-depleted filter cake as obtained in step (f) from the filter medium.

2. The method according to claim 1, wherein the solvent in step (a) comprises an aliphatic hydrocarbon having from 3 to 9 carbon atoms per molecule, or a combination thereof.

3. The method according to claim 2, wherein the solvent in step (a) comprises an aliphatic hydrocarbon having from 4 to 7 carbons per molecule, or a combination thereof.

4. The method according to claim 1, wherein the solvent-containing slurry stream provided in step (a) comprises from 30 to 60 vol. % solids.

5. The method according to claim 4, wherein the solvent-containing slurry stream provided in step (a) comprises from above 35 vol. % to below 55 vol. % solids.

6. The method according to claim 5, wherein the solvent-containing slurry stream provided in step (a) comprises from above 45 vol. % to below 55 vol. % solids.

7. The method according to claim 1, wherein the solvent-containing slurry stream provided in step (a) has a solvent-to-bitumen (S/B) weight ratio of from 0.5 to 9.0.

8. The method according to claim 7, wherein the solvent-containing slurry stream provided in step (a) has a solvent-to-bitumen (S/B) weight ratio of from 0.6 to 1.5.

9. The method according to claim 1, wherein the solvent-containing slurry stream provided in step (a) contains from 2.0 wt. % to 50 wt. % solvent, based on the weight of the solids in the solvent-containing slurry stream.

10. The method according to claim 9, wherein the solvent-containing slurry stream provided in step (a) contains from 4.0 wt. % to 25 wt. % solvent, based on the weight of the solids in the solvent-containing slurry stream.

11. The method according to claim 1, wherein the solvent-containing slurry stream provided in step (a) contains from 1.0 wt. % to 10 wt. % water, based on the weight of the solids in the solvent-containing slurry stream.

12. The method according to claim 11, wherein the solvent-containing slurry stream provided in step (a) contains from 3.0 wt. % to 7 wt. % water, based on the weight of the solids in the solvent-containing slurry stream.

13. The method according to claim 1, wherein the top section of the filter cake having substantially no liquid remaining on top of the filter cake as obtained in step (c) is remixed before liquid solvent is passed therethrough in step (d).

14. The method according to claim 1, wherein the liquid solvent-depleted top layer of the filter cake as obtained in step (d) has a temperature of from 50° C. to 100° C.

15. The method according to claim 14, wherein the liquid solvent-depleted top layer of the filter cake as obtained in step (d) has a temperature of from 60° C. to 90° C.

16. The method according to claim 1, wherein the liquid solvent in step (e) consists of an aliphatic hydrocarbon selected from the group comprising aliphatic hydrocarbons having from 3 to 9 carbon atoms per molecule, and a combination thereof.

17. The method according to claim 16, wherein the liquid solvent in step (e) consists of an aliphatic hydrocarbon selected from the group comprising aliphatic hydrocarbons having from 4 to 7 carbon atoms per molecule, and a combination thereof.

18. A rotating pan filter having a filter medium on an essentially horizontal disk rotating through sections for filtering a solvent-containing slurry stream in a non-aqueous oil sand extraction process, the sections including:
a slurry feeding section capable of providing a slurry feed onto a filter medium;
a filter cake formation section capable of forming a filter cake from slurry feed onto the filter medium in the slurry feed section;
a separation zone, in which a top layer of liquid as formed on the filter cake formed in by the filter cake formation section, and the liquid can drain through the filter cake;
a wash section, capable of providing solvent to filter cake from which the top layer of liquid has ran through the filter cake, and the solvent being able to pass through the filter cake;
a solvent removal section capable of removing residual solvent from the filter cake after the filter cake has rotated past the wash section; and
a filter cake discharge section capable of removing filter cake after the filter cake has rotated through the solvent removal section.
